(19) United States
(12) Patent Application Publication
(10) Pub. No.: US 2001/0039053 A1
(43) Pub. Date: Nov. 8, 2001

(54) Method and apparatus for handling diverse body fluids

(76) Inventors: John Liseo, Cromwell, CT (US); Joel A. Clark, Bloomfield, CT (US); Richard H. Hawley, Torrington, CT (US); Todd M. DeMatteo, Farmington, CT (US)

Correspondence Address: ST. ONGE STEWARD JOHNSTON & REENS, LLC, 986 BEDFORD STREET, STAMFORD, CT, 06905-5619, US

(21) Appl. No.: 09/904,257

(22) Filed: Jul. 12, 2001

Related U.S. Application Data
(63) Continuation-in-part of application No. 09/515,000, filed on Feb. 29, 2000.

(51) Int. Cl. G01N 35/00

(52) U.S. Cl. 436/43; 422/63; 422/100

(57) ABSTRACT

An apparatus for transporting various volumes of fluids having different viscosities into and out of a slide assembly includes a database storing data for fluids, including duration of slide assembly filling, duration of slide assembly purging and duration of slide assembly rinsing, and a controller responsive to an input which corresponds to a fluid sample selected from body fluids and having an aspiration mode, wherein the controller monitors filling of the slide assembly, a purging mode, wherein the controller monitors purging of the slide assembly and a rinsing mode, wherein the controller monitors rinsing of the slide assembly over respective durations determined by the database.

### PRIOR APPLICATION

This Patent Application is a Continuation-in-Part of Patent Application Ser. No. 09/515,000 filed Feb. 29, 2000.

### FIELD OF THE INVENTION

This invention relates to an apparatus and method for standardizing the handling of diverse body fluids so that these can be automatically transported to a slide assembly for manual counting, identification, and manipulation of microscopic elements in liquid suspensions and fluids with a microscope positioned to view the liquid suspension in the slide assembly. Specifically, this invention relates to an apparatus and method for controllably drawing a sample selected from a specimen container, such as a test tube, into an optical slide assembly and for controllably purging the sample therefrom upon completing examination. Particularly, this invention relates to an apparatus and method for controllably rinsing an interior and exterior of an aspirator probe after a suspension specimen sample has been withdrawn from a test tube with the probe to provide a clean probe for subsequent use in withdrawing another fluid sample.

### BACKGROUND OF THE INVENTION

Assemblies for analysis of fluids and methods for operating these assemblies are extensively used and practiced in clinics, laboratories and hospitals. Typically, these assemblies are required to be sufficiently efficient to process a relatively large number of analyses in a relatively short time and in a safe manner which minimizes the risk of direct contact between a user and specimens to be examined. For instance, urine sediment examination may involve pouring a sample into a tube which is then spun in a centrifuge to separate the sediment from its suspending fluid. After centrifugation, the cleared suspending fluid is poured out and the sediment is resuspended in the remaining fluid. A sample of the resuspended sample is transferred to a microscope slide for further examination.

A simple and effective system for conducting a urinalysis is disclosed in U.S. Pat. Nos. 5,248,480 and 5,393,494 to Greenfield et al. which describe an apparatus and method for drawing a fluid sample into a slide assembly for viewing through a microscope. The fluid is drawn from a container by way of a reversible pump. A urine sample is drawn in from the container through a glass slide and after viewing purged from the slide by reversing the pump so that it can be flushed back through the slide to the fluid sample container.

U.S. Pat. No. 3,352,280 describes an automatic stain apparatus for staining biological specimen. A testing apparatus is described in U.S. Pat. No. 4,025,393. An apparatus wherein a slide is moved to a staining station and then to a buffer station and thence to a rinsing station is described in U.S. Patent No. 4,034,700.

Some of the known apparatuses for the handling of samples either are too complex or involve physical exposure to the biological specimen being reviewed or are not readily suitable for a safe handling by the operator who evaluates the particular specimen in the slide.

Typically, many of the known devices and methods while being relatively well suited for conducting an examination of a particular type of fluid, may pose some problems if utilized for testing different types of fluids. One of the problems relates to maintaining desirable sanitary conditions of an aspirator probe. Indeed, using the devices designed for examining only one particular fluid, as a rule, a single aspirator probe may be used in conjunction with the same type of fluid. Clearly, such repetitive nature of the examination process requires a washing step with a certain amount of rinsing medium pumped into an interior of the aspirator probe, as disclosed in these patents. However, an unwashed exterior of the probe may, eventually, affect the quality of a urinalysis upon dipping the probe into a subsequent test tube.

This problem becomes even more severe when at least some of the known devices are employed to perform tests on different types of fluids, such as blood, cerebral spinal fluid, pericardial and the like. It is imperative that an exterior of the aspirator probe be disinfected. Yet, typically, such devices do not have a mechanism for cleaning the probe's outside.

Another problem arising from some of the known devices is that the interior of an aspirator probe and the interior of the slide assembly have to be rinsed by different concentrated rinsing media to effectively clean the interior after conducting tests on the same fluids or fluids of different viscosity. As a result, washing periods may vary since cleaning of the interior of the slide assembly would take a relatively long time after it has been filled with a relatively highly viscous fluid in comparison with a low viscosity fluid. Thus, using the same rinsing liquid for the same period of time to clean an aspiration probe that has been used for a urinalysis and a blood test may have different effects, since a highly-viscous fluid, such as blood, is more difficult to wash away than a low viscous urine. Once again, since the devices and methods, as discussed here, predominantly work with the same fluid, they do not selectively wash the interior of the probe traversed by a variety of fluids.

Still another problem that the devices and techniques predominantly used for testing a particular fluid may have when they are used to conduct tests on different fluids may be that durations of filling an optical slide assembly with differently viscous fluids vary. As mentioned above, an optical slide assembly used in these devices allows the specimen to be made optically visible to a device such as a microscope, camera, photo-detector, and a combination thereof or other type of optical gathering input device. The image and spectral information obtained via the input device is processed to classify and to enhance the image and image data and to perform recognition and analysis of the drawn specimen.

In order to achieve a reasonably consistent basis for analysis, preferably the same volume of fluid should be delivered to the optical slide assembly. This is achieved in some of the known devices by a substantially uniform pump's mode of operation including, for instance, duration of a pumping phase and/or a rate of pumping. However, this mode may be inadequate if fluids had viscosity higher or lower than the fluid for which a device was designed. For example, a highly viscous fluid, such as blood, requires that the pump work either for a relatively long period of time or at a relatively high rate to enable an amount of blood sufficient for its evaluation to be accumulated in the slide assembly. Yet, at least some of the known devices do not provide an automatic setting of the pump allowing a user to preprogram it so as to have different modes of the pump's operation according to differently viscous fluids.

All of the above discussed disadvantages may be characteristic of a purging phase of at least some of the known devices. In order to drain the tested fluid from an aspirator probe and a slide assembly, a user should know the duration of a pump's operation so as to completely empty them. Thus, similar to an aspiration mode, different time periods of purging are required to displace the same volume of variously viscous fluids from the aspiration probe.

Further, differently viscous fluids may require different solutions capable of thoroughly washing an interior of a slide assembly to. The more viscous a fluid is the more highly concentrated flush solution may be used to overcome adhesion of such fluid to the interior of the slide assembly.

What is desired, therefore, is an apparatus and method for controllably transporting a wide variety of specimens into and out of the optical slide assembly. An apparatus and method for automatically controlling a mode of operation of a fluid delivering mechanism so as to supply a predetermined amount of each type of specimen selected from a variety of fluids to the optical slide assembly is also desirable. Also, an apparatus and method for automatically rinsing an exterior of an aspiration probe is desirable, as is an apparatus and method for controllably rinsing an interior of the aspiration probe and an optical slide assembly.

### SUMMARY OF THE INVENTION

With an apparatus in accordance with the invention, a user can perform determination of specimen morphology of a wide range of fluids in an efficient, hygienic, inexpensive and consistent manner by using a computerized menu including a plurality of pre-programmed set-ups for different fluids.

This is achieved with one apparatus in accordance with the invention by utilizing a fluid controller for displacing a nominal volume of differently viscous fluids into and out of an optical slide assembly for viewing by an optical gathering device. More particularly, this controller enables a pump to draw a controlled amount of fluid or liquid suspension through an aspirator probe into the optical slide assembly and subsequently to flush it away in a controlled timely manner in effect based on a particular viscosity of the tested fluid sample. Thus, a variety of different body fluids can be rapidly and efficiently analyzed.

The device according to the invention includes a front panel with a menu screen with which a user can select the fluid to be handled and examined inside the slide assembly. In response to the user's selection, the transportation of a sample of a liquid suspension from inside a test tube will be done based upon a previously determined pumping profile that may include required volume displacement and pumping speed, and which have been empirically determined and stored in a database. This pumping profile is sufficient to allow a nominal volume of the selected fluid to be aspired into and then purged out of an optical slide assembly.

Specimen containers as shown in the aforementioned '480 and '494 U.S. Patents, which may be test tubes or the like, are removably mounted at a test station of the apparatus where an aspirator probe can be inserted into one of the tubes containing a selected fluid sample to be tested. The container, thus, may contain a liquid suspension, having a specific viscosity. After turning the controller on a user selects the type of liquid suspension to moved from the test tube and this causes the controller to operate the pump by displacing the liquid from the test tube into the slide assembly while running for a period of time determined by a schedule as stored in a data base inside the controller for the particular type of liquid in the test tube.

Typically for anyone set up, including the aspirator probe and connected tubing, the amount of displaced liquid is the same for different types of liquids. As a consequence, the duration of the pump's operation or the pump's rate can be made specific for each particular liquid and this typically depends on its viscosity as represented by the applicable data stored in the database. Upon completion of the examination, the controller reverses a direction of rotation of the pump for a pre-programmed period of time sufficient to completely purge the tested fluid sample out from the slide assembly and the probe in accordance with a purging phase applicable to the selected liquid.

When a particular volume of a liquid suspension is to be displaced from a test tube the previously determined and stored pumping profile for the liquid provides all necessary information, such as the time that the pump needs to be activated to secure the desired function, such as a loading of or a purging of the sample from the slide assembly.

The controller may include a microprocessor querying a database that contains the pumping profiles and relevant program steps used to control various digital and analog electronic elements used to operate the pump and associated valves. A variety of valve arrangements is used and automatically set to implement a working cycle of the apparatus whereby a fluid sample is aspirated from a test tube into the slide assembly, purged from it and enables subsequent rinsing of the apparatus.

With the pump working to deliver a fluid sample into the optical slide assembly and purge it back out, the controller monitors a pressure in the system to prevent it from going where it can damage the valves and other components used in the apparatus. As a consequence, displacement of the fluid is monitored by a controller which stops the pump if a high pressure has been detected. Once the pressure is normalized, the pump can be automatically or manually turned on in an operating mode that has been interrupted.

The versatility and effectiveness of an apparatus in accordance with the invention is further enhanced by use of a rinsing operation allowing a user to operate with a single aspiration probe for guiding a plurality of fluid samples toward an optical slide assembly. After the examination is completed, a user can flush a tested fluid sample back to a tube by reversing the rotational direction of the pump and then drive a washing fluid, which typically includes saline and bleach.

Alternatively, the probe may be placed at a washing station of the apparatus wherein two bays are provided to sequentially receive the probe. Upon automatically detecting the presence of the probe in either bay, a specific arrangement of valves allows a washing fluid to traverse the probe thereby flushing a tested fluid sample into a waste basin that may be arranged under the housing. The more viscous a fluid sample is, the higher concentration of bleach is used to provide satisfactory cleaning of the probe. This is because highly viscous fluids tend to stick to the interior of a fluid conveying component. Once again, based on experimental data stored in a software, the washing fluid mixture and duration of the purging operation, as explained above, can be automatically preset as part of a particular setup for a tested fluid.

In order to have an exterior of the probe rinsed, each bay has a plurality of sprayheads for spraying a cleaning fluid upon the exterior of an aspiration probe. A number and location of the sprayheads may vary to meet cleaning requirements. Upon completion of a showering stage, a pair of wipers including brushes, pads or the like are activated by the controller to grasp the outside of the probe which then is pulled through the wipers to have its exterior wiped clean.

With the apparatus in accordance with the invention, problems encountered with other testing and cleaning devices are avoided.

It is, therefore, an object of the invention to provide an apparatus and technique with which a variety of body fluids can be handled for examination inside a slide assembly in a convenient, safe and expeditious manner.

It is a further object of the invention to provide an apparatus and technique for transporting different body fluids and cleaning conduits used in equipment through which samples of the body fluids are passed.

It is still another object of the invention to provide an apparatus and technique for automatically pre-selecting a working cycle of pump operation including aspiration and purging modes which durations are a function of viscosity of a body fluid sample to be examined in a slide assembly.

It is another object of the invention to provide an apparatus and technique for automatically selecting a rinsing cycle as a function of viscosity of a sample of a body liquid suspension.

It is a further object of the invention to provide an apparatus and technique for automatically rinsing and cleaning an exterior of aspiration probe upon completion of examination of a fluid sample.

It is still a further object of the invention to provide an apparatus for easily adjusting an aspiration probe to fit differently sized tubes containing fluid samples.

It is yet a further object of the invention to provide an apparatus and technique for reliably protecting a user from contact with fluid samples and with rinsing fluid.

### BRIEF DESCRIPTION OF THE DRAWING

FIG. 1 is a front perspective view of a body fluid handling apparatus in accordance with the invention.

FIG. 2 is a flow chart illustrating a work of the apparatus of FIG. 1.

FIG. 3A₁ is a graphical representation of steps of a stepper motor during an aspiration phase for a watery solution in accordance with the invention.

FIG. 3A₂ is a pressure versus time graph illustrating changes in the system pressure during the aspiration phase of FIG. 3A₁.

FIG. 3A₃ is a graphical representation of displacing a nominal volume of fluid sample displaceable into an optical slide assembly during the aspiration phase of FIG. 3A₁.

FIGS. 3B₁, 3B₂ and 3B₃ are graphical representations identical to FIGS. 3A₁-3A₃ but for a highly viscous fluid in accordance with the invention.

FIG. 3C is a graphical representation of an increased rate of a stepper motor operating during the same period of time as the stepper motor of FIG. 3A₁.

FIG. 4A₁ is a graphical representation of a stepper motor during purging a low-viscous fluid from the optical slide assembly of the apparatus in accordance with the invention.

FIG. 4A₂ is a pressure versus time graph illustrating changes in the system pressure during the purging phase of FIG. 4A₁.

FIG. 4A₃ is a graphical representation of displacing a nominal volume of fluid sample displaceable from an optical slide assembly during the purging phase of FIG. 4A₁.

FIGS. 4B₁, 4B₂ and 4B₃ are graphical representations similar to FIGS. 4A₁-4A₃ but for purging a highly viscous fluid.

FIGS. 4C₁-4C₂ illustrate a work of stepper motor and pressure changes in a system during displacement of a nominal volume of tested fluid upon detecting a high pressure.

FIGS. 4D₁-4D₃ are graphical representations similar to FIGS. 4A₁-4A₃ and illustrating a purging phase, wherein a pump does not have capacity to displace a nominal volume during a single cycle.

FIG. 5 is an electro-hydraulic schematic view of fluid sample supply and rinsing system of the apparatus shown in FIG. 1.

FIG. 6 is a block diagram illustrating a sequence of operational phases of the apparatus in accordance with the invention.

FIG. 7 is a top sectional view of a washing station of the apparatus shown in FIG. 1.

FIG. 8 is a side sectional view of the washing station of FIG. 7 taken along a vertical axis.

FIG. 9 is a front sectional view of the washing station shown in FIG. 8 in accordance with the apparatus of the invention, as illustrated in FIG. 1.

FIG. 10 is a top schematic view of an exterior-cleaning device of the apparatus in accordance with the invention shown in a rest position.

FIG. 11 is a view of the exterior-cleaning device similar to the one shown in FIG. 10, but illustrated here in its working position.

FIG. 12 is a side schematic view of the exterior-cleaning device shown in FIG. 10.

FIG. 13 is a schematic view of an aspirator probe in accordance with the invention.

FIG. 14 is a schematic cross-sectional view of a peristaltic pump taken along a motor axis.

FIG. 15 is a cross section view of the pump of FIG. 14 taken along an axis perpendicular to the motor axis.

### DETAILED DESCRIPTION OF THE DRAWINGS

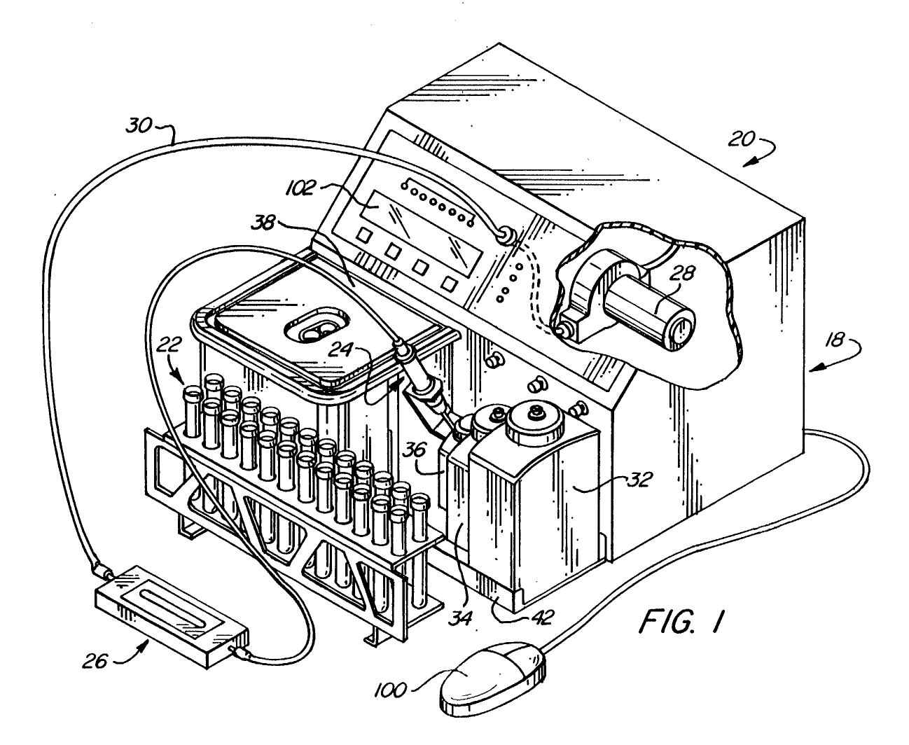

With reference to FIGS. 1-6, an apparatus 20 is shown with which a variety of body fluid samples is drawn from a collection of test tubes 22 by an aspirator probe 24 and pulled through an optical slide assembly 26 under an optical device, which is not shown here. The apparatus 20 has a casing 18 enclosing a pump 28, which while operating in an aspiration mode draws a fluid sample through the probe 24 and a flexible tube 30 into the slide assembly 26 so as to enable a user to administer a test.

Upon completion of the test, the apparatus is automatically switched to a purging mode, wherein the sample fluid may be purged out back to a test tube by displacing a volume of flushing fluid stored in a reservoir 34. Preferably, the pump 28 is a reversible peristaltic pump driven by a stepper motor 50, as will be explained hereinbelow. Note, however, that a type of pump can be selected from a wide range including, for example, rotating piston, Harvard syringe and/or continuously operated pumps.

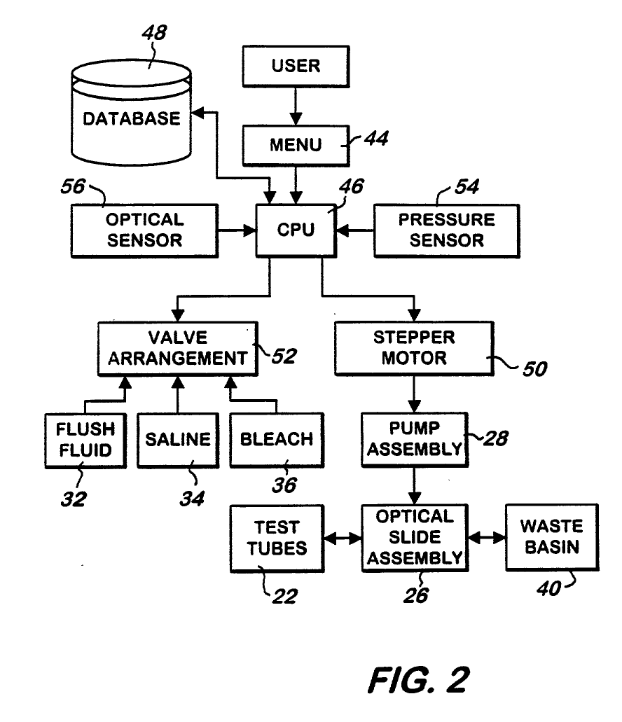

Alternatively, the purging mode can be accomplished by placing the aspirator probe 24 at a washing station 38, wherein a sample fluid is displaced from the probe into the waste basin 40 (FIG. 2). This is accomplished by selectively supplying saline and bleach contained in containers 34, 36, respectively, which are preferably mounted on a tray 42 to the interior of the probe. Also, an exterior surface of the aspirator probe is rinsed, as will be explained in detail hereinbelow.

According to one aspect of the invention shown in FIG. 2, the apparatus 20 has a central processing unit 46 programmed to carry out a plurality of microinstructions defining the individual operations and their durations in response to a fluid sample selection made by a user on a menu 44. Preferably, the CPU 46 is an off-the-shelve microprocessor controlling a direction of rotation and speeds of the pump 28 in response to signals generated by a variety of pressure and optical sensors 54, 56. Also, the microprocessor controls valve arrangements 52 upon querying a database 48, as will be explained in detail here-in-below.

Specifically, as mentioned above, the apparatus 20 is constructed to provide a test of different body fluids having different viscosities. A fluid sample may be selected from the group consisting of a cerebral spinal fluid, pericardial, pleural, seminal, serum, urine sediment, blood, prostate or vaginal suspension and any other body fluid collected by a needle.

Such a wide range of viscosities requires different time periods for displacing a sufficient volume of fluid sample to be examined from the test tube 22 into the optical slide assembly 26. As mentioned in U.S. Pat. No. 5,393,494, the slide assembly 26 presents the specimen to an optical gathering input device such as a microscope.

The slide assembly of this invention may be configured with a counting grid. The counting grid facilitates quantitative measurements, such as cell counting. Counting lines can be fine metallic lines deposited by means of vapor deposition methods. The lines thus formed, however, mask specimens located behind the grids from view. Preferably, in accordance with the invention, a glass bottom of the slide assembly 26 is etched with acid which forms whitish lines that do not obstruct the view of the specimen, thereby enabling better determination of specimen morphology.

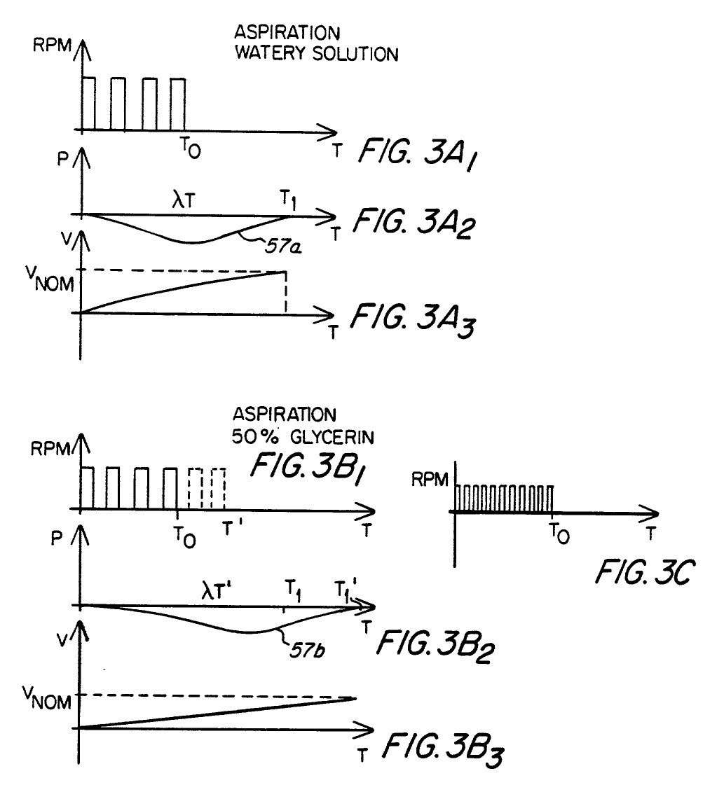

Turning to FIGS. 3A and 3B, graphs 57a and 57b illustrate curves of pressure as a function of time in conduits while different fluids are conveyed through the aspirator probe to the slide assembly 26. Since the volume Vₙₒₘ of a fluid sample sufficient to reach the slide assembly 26 is uniform for different fluids, the time it takes for a sample to reach the slide assembly tends to vary as a function of fluid viscosity. This then requires that the duration of the pumping action by pump 28 be adjusted depending upon the fluid that is being transported.

Accordingly numerous pump duration measuring tests have been conducted using a variety of glycerin concentrations in a watery solution to simulate and thus represent viscosities of different body fluids. Understandably, the more viscous the fluid sample is the longer time pump 28 requires to move the fluid's volume into the slide assembly at any given pumping rate.

Thus, for example, FIGS. 3A and 3B respectively illustrate pumping intervals for aspiration of a watery solution corresponding to a urine sample and a solution containing 50% of glycerin that may correspond to a blood sample, respectively. To aspire a fluid sample from the tube 22, a negative pressure, as shown in FIG. 3A₂, is generated downstream of the aspirator probe 24 allowing the fluid sample to be withdrawn from the tube 22. Note the different pumping times that are needed to move a sample to slide assembly 26. After the pump is automatically shut down in a controlled timely manner, as will be explained hereinafter, the system pressure monitored by the pressure sensor 54 will gradually reach zero and, after the optical slide assembly 26 receives the nominal volume of aspired body fluid, a test can be conducted.

Comparison of these graphs shows that if the pump has a uniform pumping rate and works during the same time period T₀, an aspiration period λT=T1 sufficient for displacement of a volume of the low-viscous fluid is not adequate for displacing the same volume of a higher viscosity fluid. Hence, a period λT′=T′₁, as shown in FIG. 3B₂, during which the same volume of highly-viscous fluid can be aspired into the slide assembly is greater than λT for the low viscous fluid. Thus, the same number of rotations of the pump sufficient for transporting a low-viscous fluid is likely to be inadequate for transporting a more viscous fluid. To overcome it, based on experimental data, the number of rotations of the pump has to be varied in accordance with the viscosity of fluid sample to be examined, as shown in dash lines in FIG. 3B₁.

This can be done by adding a few more steps to a stepper motor 50 (FIG. 2) driving the pump without, however, changing a step rate of the motor, as illustrated by dash lines in FIG. 3B₁. As a result, the duration of pump operation during this aspiration phase will be increased. Alternatively, the step rate of the motor 50, as shown in FIG. 3C, may be increased, which, in turn, leads to an increased number of rotations during the same period of time. Preferably, in order to keep the flow of fluid sample steady in the aspiration mode, a step rate of the stepper motor is varied while duration of this mode remains constant.

The values for the stepper motor parameters, i.e. the step rate or speed of the pump driven by the motor, as well as the duration the pump is on, are stored in a database as a function of the various body fluids, and thus in effect their respective viscosities.

Thus, a table of pumping parameters is embedded in a database and used by the microprocessor programs. The database includes pumping durations, and pumping speed for each different body fluid of interest. Pumping speed can be in terms of the desired step rate for a stepper motor used to drive the pump. If instead of a peristaltic pump another type of pump is utilized, then a set of different parameters, such as the displacement of a spindle in a Harvard type pump or the like will be stored.

A similar process is used to determine and store the parameters for a purging mode during which the body fluid in the slide assembly and connected conduits is to be purged.

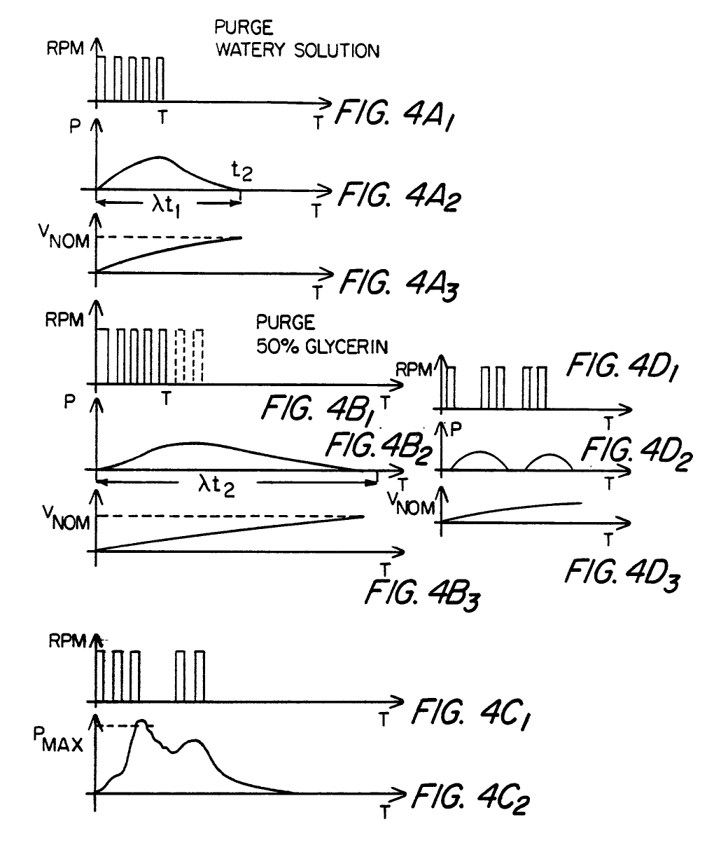

Having finished examination of the fluid sample, software executing on the microprocessor switches the apparatus into a purging mode to displace the fluid sample from the slide assembly back through conduits and the aspirator probe as shown in FIGS. 4A₁-4A₂ and 4B₁-4B₂. Similarly to FIGS. 3A and 3B, the examples shown in FIGS. 4A and 4B represent the watery solution and the 50% glycerin concentrated solution, respectively.

Purging is implemented by reversing the direction of rotation of the pump and driving a washing fluid from reservoir 32 through the slide assembly and displace the body fluid sample. The time required to displace the body fluid or its simulated version is noted and stored in the database.

In accordance with the invention, a purging period for each tested body fluid is tabulated and stored similarly to aspiration periods. Control of this purging period is provided by the microprocessor 46 enabling the stepper motor to have a predetermined number of steps sufficient to operate the pump, so that it displaces the volume of fluid sample from the aspirator probe and the optical slide assembly.

As is seen in FIGS. 4A and 4B, during displacement of the same amount of fluid, a period λAt₁ for the low-viscous fluid is substantially shorter than a period λt₂ for the highly viscous fluid. Similar to the aspiration mode of operation, the number of steps of the stepper motor can be adjusted by either modifying duration of the motor's work while maintaining a constant step rate for all fluids or by changing the step rate. The more viscous fluid is the longer the stepper motor and the pump should work to displace a sufficient volume of this fluid. Alternatively, a step rate of the stepper motor may be increased to move a more viscous while maintaining the duration of the pumping period.

Also, as shown in FIGS. 4C₁ and 4C₂, a program executing on the microprocessor for stopping the pump if the pressure in the system exceeds a threshold pressure is provided. It is imperative that this pressure be kept in check to avoid high pressure damage to fluid-conveying components of the apparatus 20 including the slide assembly 26, valves 52 and flexible tubes and hoses 30. Thus, once the system pressure, as indicated by the pressure sensor 54 (FIG. 2), reaches the threshold value Pₘₐₓ, the step motor 50 is stopped. After the pressure Pₘₐₓ has subsided, a count of motor steps resumes so it can reach a stored value. Although this feature has been explained in reference to a purging phase, it is understood that an aspiration phase can be easily controlled in the same manner.

A number of pump work series necessary for displacing the controlled volume of fluid depends on volume capabilities of any given pump. Typically, an amount of travel of the pump's piston is limited, thereby necessitating to reload the pump with a new portion of flushing fluid so as to have the controlled volume of fluid sample fully displaced. For example, if a nominal volume of fluid to be displaced is equal to 900 micro liters, then in order to a use pump that is capable of displacing, for instance only 700 micro liters, it should be turned on twice, as shown in FIG. 4D₁. As a result, one of the pumping series may be somewhat shorter than the other one. As is the case with the duration of pump work and pumping speeds, a program executing on the microprocessor 46 for each fluid provides automatic stoppage and reloading of the pump so the nominal volume is fully displaced.

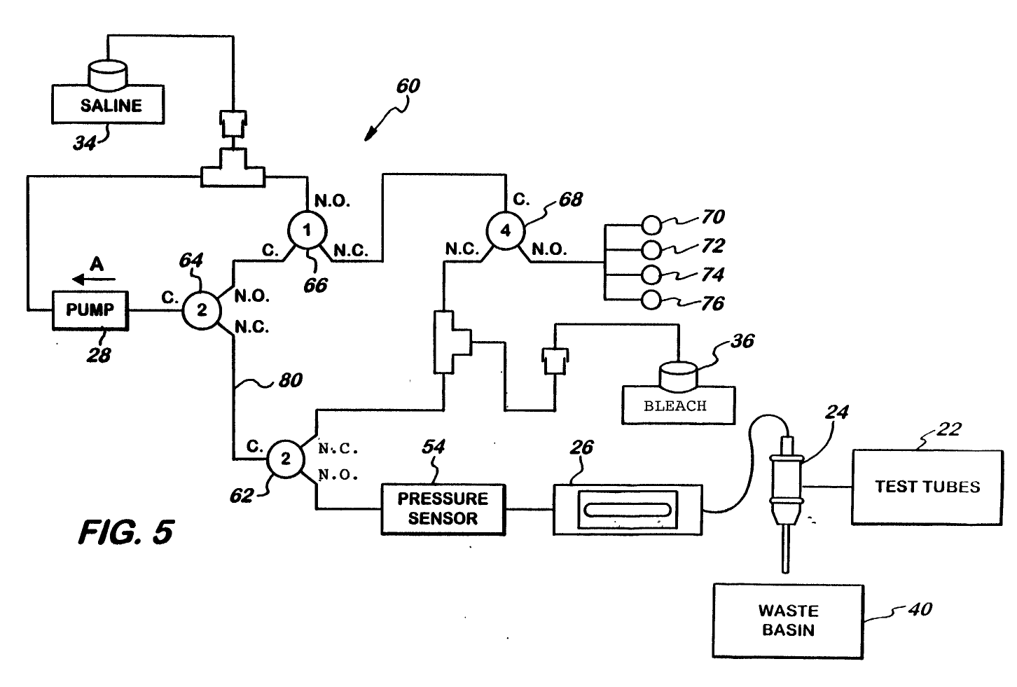

FIG. 5 illustrates an electro-hydraulic system 60 having a plurality of three-way controllable valves 62, 64, 66 and 68 selectively switched to form a variety of fluid passages during aspiration, purging and washing modes of the apparatus 20 according to a microprogram executing on the microprocessor. Each of the three-way valves has normally open, normally closed and common ports, which upon energizing the valve change their normal states.

During aspiration of fluid sample into the optical slide 26 assembly through the aspiration probe 24, the pump's piston is displaceable in a direction of arrow “A” creating negative pressure downstream from the test tube 22 to draw a fluid sample into the slide assembly 26. In order to implement this mode, the valve 64 is energized to enable its normally closed port to open. Upon a predetermined period of time sufficient for displacing the nominal volume of tested fluid, as explained above, the valve 64 is de-energized allowing a user to conduct examination of the fluid sample.

To purge the fluid sample out of the slide assembly 26 back to the tube 22, the valve 64 is once again energized providing a passage for flushing fluid, which displaces the fluid sample following reversal of the pumping direction of pump 28.

According to another aspect of the invention, in order to adequately clean an interior of the slide assembly and the aspiration probe 24 so as not to contaminate the subsequent examination of another fluid, a bleach/saline solution may be used. Such solution is particularly useful when a highly viscous fluid has been tested because it tends to stick to the interior walls of the fluid conveying components. This washing mode is automatic and is used when the contents of the fluid conveying line have to be discharged into the waste basin 40.

After automatically energizing valve 62, as will be explained hereinbelow, its normally closed port is open and the bleach reservoir 36 is in fluid communication with a passage 80 extending between the valves 62-64, thereby allowing bleach to enter this passage upon displacing the pump's piston in the direction “A”. After a predetermined period of time controlled by the microprocessor 46, the valve 62 is switched again and a direction of the pump is reversed. As a consequence, a saline/bleach solution enters both the optical slide assembly and the aspirator probe to displace the fluid sample therefrom and to clean the interior of these elements.

The electro-hydraulic system 60 further has a plurality of controllable wash valves 70, 72, 74 and 76, preferably two-way valves, which are arranged to rinse an exterior of the aspirator probe 24 which is placed at the bay station 38, as will be explained hereinbelow. To supply washing solution to the exterior of the probe, valves 66 and 68 are sequenced by the CPU software allowing a passage of the saline/bleach solution through these wash valves.

Note that each of the above-described valves is given only as an example, and instead of being three- and two-way valves, other types of valves may be easily utilized. Also note that the above-shown arrangement of these valves is given for illustration only and may vary within the disclosed mode of operations.

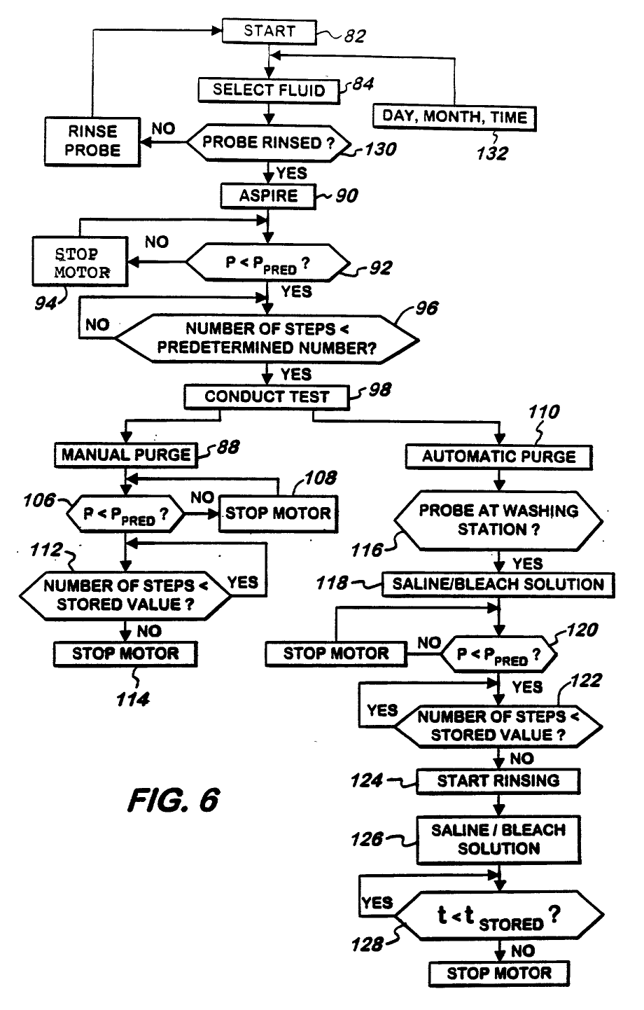

A work of the apparatus 20 is better illustrated in FIG. 6 showing a flow chart, which depicts the pre-programmed sequence of operations controlled by the microprocessor 46. Turning to FIG. 1, the housing 18 has a screen 102 helping a user navigate through the menu 44 including a variety of fluid identifications each of which is to be treated according to a respective micro-program executing on the microprocessor. After turning the apparatus 20 on at 82, as shown in FIG. 6, the user by using a mouse 100 or a front panel button 162 (FIG. 1) runs up or down along a list of fluids that can be tested by this apparatus 20 at 84 and selects a fluid. This selection loads the associated pumping data from the database to control subsequent aspiration and purging modes.

Having chosen the fluid, a working cycle starts with the aspiration mode at 90. During the entire duration of the aspiration mode, the pressure in fluid conveying components is monitored at 92, and if it exceeds a predetermined threshold value Pₘₐₓ, displacement of a fluid sample is interrupted until the pressure falls back within acceptable limits, after which the aspiration mode is continued. If an actual number of steps is less than a predetermined number of the motor steps as required by the pumping data loaded from the database, as shown at 96, then the pump continues to work until the actual number of steps reaches this threshold, at which point the sample of the fluid from the test tube has arrived within the slide assembly and a user can conduct an examination of the sample at 98.

During the purging mode the microprocessor switches the apparatus in a selected purging mode, for example a manual purging mode at 88, wherein the rotation of pump is reversed to displace the fluid sample back into a test tube from the slide assembly 26 by pumping a saline/bleach solution. The pressure is monitored at 106, and similarly to the aspiration mode, the stepper motor is stopped if a threshold value Pₘₐₓ is reached or exceeded. If a number of actual steps at 112 has not yet reached a predetermined number, the pump keeps working until the predetermined number of steps is exceeded, indicating complete evacuation of the fluid sample from the slide assembly 26 and the aspiration probe 24. Thus, at this point, the working cycle is completed at 114, and the apparatus is ready for examination of another fluid sample.

If the automatic purging mode is selected at 110, its sequence starts with detecting the aspirator probe at the washing station 38 at 116 which is accompanied by automatically setting a pre-programmed arrangement of controllable valves, as has been explained before, to prepare a proper bleach/saline solution at 118. In addition, as has been mentioned before, the automatic purging mode includes a rinsing or washing phase 124, wherein the exterior surface of the aspirator probe 24 is cleaned by a saline/bleach solution at 126. This phase can be monitored by pre-programming a predetermined period of time or by counting a number of steps of the stepper motor at 128. Thus, if the number of step is still less than a predetermined number of steps, the rinsing step continues until the actual number of steps exceeds the predetermined number, at which point the pump stops.

An additional feature of this invention is that if the aspirator probe has not been purged as indicated at 130, the apparatus cannot start a new aspiration phase. According to another possible feature, before starting the working cycle of the apparatus, the day, month and year of conducting a test are automatically stored in the database at 132. Further, it is possible to have the entire duration of the cycle monitored so as to enable a user to gather information about his productivity during a certain time period, such as an hour, day and the like.

It should be understood that a wide variety of different setups can be pre-programmed and the one that is shown and explained is given merely as an example. It is conceived within a scope of this invention that a user may change the previously stored parameters or even test previously untested fluids by manually introducing all necessary parameters in response to a series of questions appearing on the screen 102. Thus, durations of purging, aspiration and rinsing modes may be modified depending on fluid conducting components, optical equipment, and etc. Once new data is introduced, it will be stored allowing the user to automatically test the fluid whenever it will be necessary in the future using the apparatus of this invention.

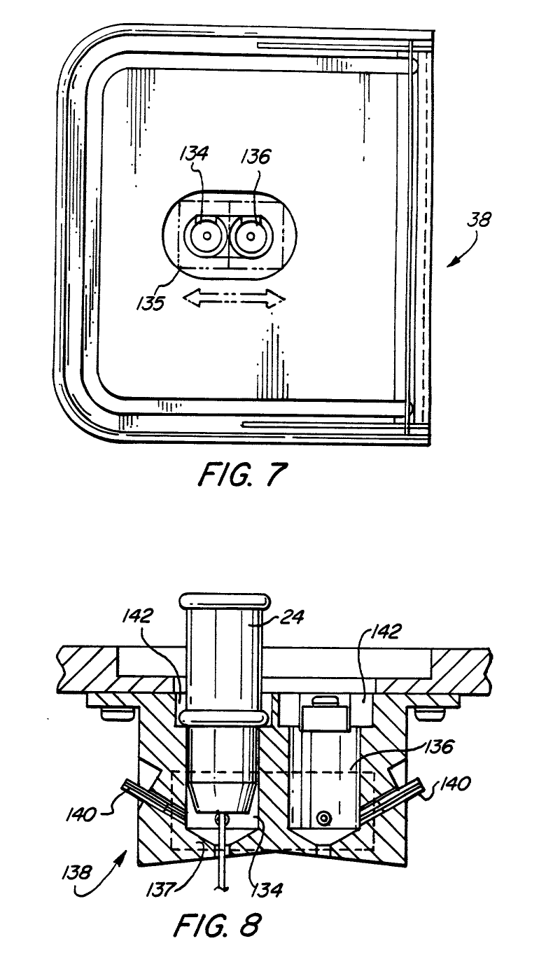

FIGS. 7-12 illustrate another aspect of the invention, according to which the apparatus 20 is provided with a mechanism for cleaning an exterior surface of the aspirator probe 24, as has been mentioned before. Particularly, FIGS. 7-9 show the washing station 38 having a housing 138 with purge 134 and rinse 136 bays, each extending into the housing and sequentially receiving the aspiration probe 24. Both bays 134 and 136 are in fluid flow communication with the waste basin 40 so that a purged fluid sample along with washing and rinsing liquids are collected in the basin after the examination of a fluid sample has been completed. A plurality of the external wash nozzles 140 (FIG. 8) which are in flow communication with two-way valves 70-76 (FIG. 5) peripherally surround the inserted aspiration probe whose presence is detected by an optical sensor 142 generating a signal turning on the microprocessor 46 in the automatic purging mode. A number of wash nozzles varies and is selected so as to provide uniform distribution of the rinsing liquid along and around an exterior of the aspiration probe.

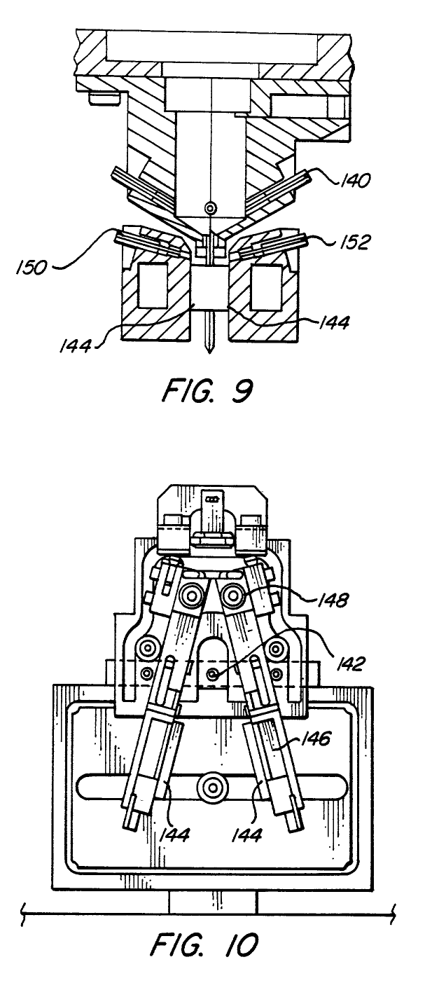

In accordance with another aspect of the invention, each of the bays 134, 136 has a pair of wiping pads 144 (FIG. 10) which are strategically located to wipe the aspiration probe after its periphery has been sprinkled from the wash nozzles 140, as shown in FIG. 9. The pads 144 are removably attached to swingable arms 146 actuated upon energizing a solenoid 148 to move between a rest and wiping position as shown in FIGS. 10 and 11, respectively.

When the aspirator probe is first inserted into the purge bay 134, the optical sensor 142 detects it and starts purging the optical slide assembly 26 through the aspirator probe into the catch basin. Also saline and bleach are dispensed on the outside of the probe thus washing it. After completion of the purging mode, the swingable arms are pressed against the probe, which is squeezed by the wiping pads 144. A user is then prompted to pull the probe 24, which is wiped clean from the purge bay.

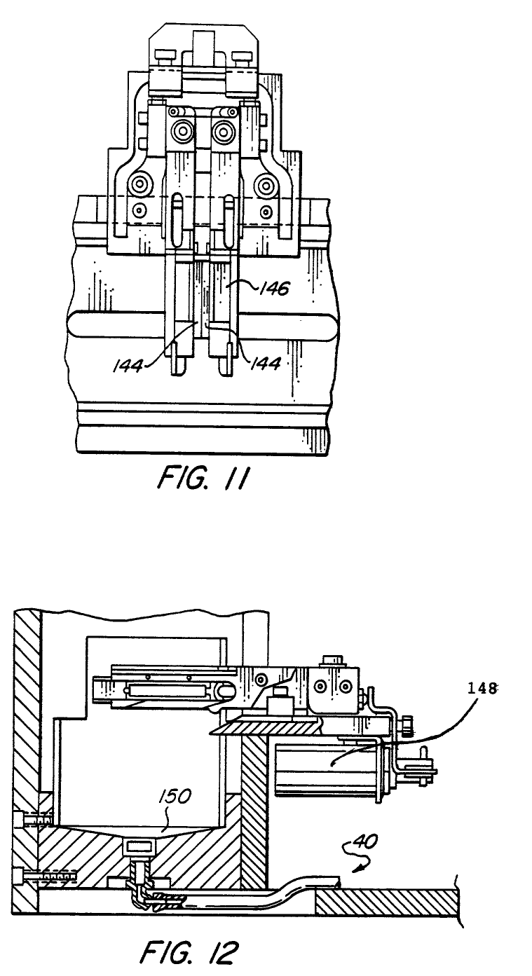

The user then introduces the aspirator probe into the rinse bay 136. Similarly to the procedure explained with respect to the purge bay, the aspirator probe is optically detected and then rinsed before pulling out of the rinse bay by the user. However, a location of wiping pads in the rinse bay is different from a position of the pads in the purge bay 134 to allow the entire exterior of the probe to be thoroughly cleaned. After removing the probe from the washing station 38, the wiping pads are rinsed with saline and bleach delivered by nozzles 152 (FIG. 9) from the reservoirs 34, 36. Upon completion of washing and rinsing operations, all fluids collected in a catch basin 150 are further delivered to a waste container 32 as a result of actuation of a waste pump as shown in FIG. 12. Although the purging, washing/rinsing and evacuating operations in the automatic purging mode have been described as sequential, installation of more than one pump can provide simultaneous rinsing, draining and purging.

During the automatic purging mode the user is prevented from contact with fluids by a spring loaded cover 137 mounted on the front door of the washing station and schematically shown in FIG. 8. Further, as shown in FIG. 7, a sliding shutter mechanism 135 can be installed to automatically cover the top of either of the bays which is not in use, so as to prevent fluids from exiting through the open top during purging and washing.

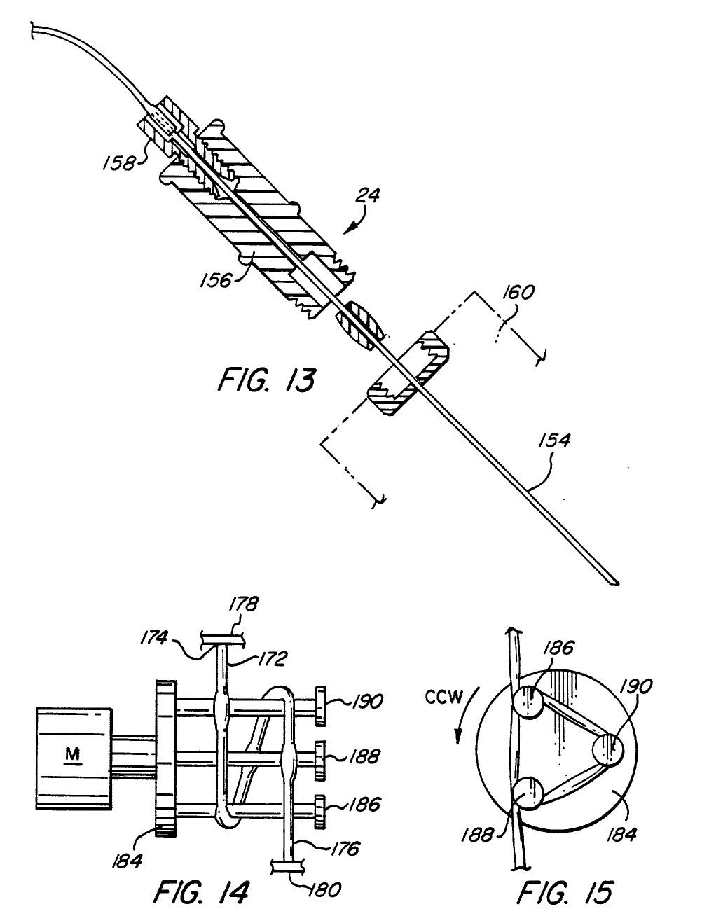

In accordance with still another aspect of the invention, the aspirator probe 24 shown in FIG. 13 includes a needle 154 adjustably mounted to a handle 156. In order to fit the aspirator probe to differently sized test tubes 22, the probe is provided with a nut 158 allowing the needle 154 and the handle to move relative one another. Once a desirable length is reached, the nut is tightened up so as to prevent further displacement of the needle. Alternatively, a compression fitting 160 schematically shown in FIG. 13 can be used instead of the nut.

In accordance with still another aspect of the invention shown in FIG. 14, if a peristaltic pump 170 is used, the tubing is directly occluded by a plurality of rollers 186,188 and 190 without using a cartridge, which is typical for this type of pump. Particularly, opposite ends 174 and 176 of tubing 172 are attached to stationary top and bottom holders 178 and 180, respectively. Shown only as an example, the pump has three rollers rotatably mounted on a disc 184 which, in turn, is actuated by a motor M. Assuming that the disc 184 is rotated in the counterclockwise direction, as shown in FIG. 15, the tubing wrapped about the roller 186 will be traversed by fluid entering the open top end 174 and exiting at the opposite bottom end 176. By virtue of a structure in which the roller 186 occludes the tubing which further is hung over the roller 190, a trapped volume of fluid between adjacent pinch areas is created. As the disc 184 rotates, this trapped volume of fluid is transferred between the roller occluded pinch areas because they are traveling with respect to the stationary tubing. As a result, fluid enters one end of the tubing and exits the other. The volume of fluid transported depends on the internal diameter of the tubing and the speed of the motor.

Having thus described illustrative forms of the invention, its advantages can be appreciated. Variations from the described embodiment can be made without departing from the scope of the invention. What is claimed is:

1. An apparatus for transporting a volume of liquid suspension including a body fluid having a viscosity into and out of a slide assembly, comprising:
a database storing data related to different liquid suspensions including data representative of durations of slide assembly filling, data representative of durations of slide assembly purging;
a controller responsive to an input signal representative of a selected liquid suspension said controller filling of the slide assembly with said selected liquid suspension for a time period determined by corresponding filling data in said database, said controller further having a purging mode for purging of the slide assembly for a time period determined by corresponding purging data in said database.

2. The apparatus defined in claim 1 wherein the database further has data representative of durations of slide assembly rinsing for respective liquid suspensions and wherein said controller further has a rinsing mode in which the controller enables rinsing of the slide assembly for a duration determined by corresponding rinsing data in the database.

3. The apparatus defined in claim 1 wherein the apparatus further comprises a menu screen showing a list of the stored liquid suspensions, and a liquid suspension selector operated by the user to select the filling and purging modes data associated with the selected liquid suspension.

4. An apparatus for transporting liquid suspensions of different viscosities for analysis within an optical device from test tubes which contain a liquid suspension having a viscosity that influences the time for a sample of the suspension to travel between a test tube and a slide assembly for analysis and purging of the sample, comprising:
slide assembly in flow communication with one of said test tubes for viewing a sample of liquid suspension selected by a user;
a pump assembly having an aspiration mode to pump the sample into the slide assembly, and a purging mode to pump the sample from the slide assembly;
a database for storing pumping data for pumping different liquid suspensions of different viscosities into and out of the slide assembly with said pump assembly
a controller responsive to an input signal representative of a selected liquid suspension sample for applying corresponding pumping data from the database to control the pump assembly to aspirate the desired liquid suspension from said one test tube into said slide assembly and to purge the liquid suspension from the slide assembly

5. The apparatus defined in claim 6 wherein the wherein the pumping data in the database comprises data representative of values of durations for respective liquid suspensions to travel into and from the slide assembly.

6. The apparatus defined in claim 6 wherein the aspiration probe has a handle sized and shaped to mount on an open end of a test tube and a needle extending through said handle and being displaceable relative to the handle to adjust the length of the needle extending into a test tube apparatus defined in 9 wherein the aspirator probe further has an adjustable component selected from the group consisting of a compression fitting and a regulating nut.

7. The apparatus defined in 9 wherein the aspirator probe further has an adjustable component selected from the group consisting of a compression fitting and a regulating nut.

8. The apparatus defined in claim 6 wherein the slide assembly has a viewing chamber provided with a counting grid formed of a plurality of grid lines.

9. The apparatus defined in claim 11 wherein the viewing chamber is formed of glass and wherein said grid lines are etched into the glass so as not to obstruct the view of the liquid suspension sample.

10. The apparatus defined in claim 6 wherein the apparatus has a plurality of containers respectively for storing flushing liquid, saline and bleach, the containers being in selective flow communication with the pump assembly.

11. The apparatus defined in claim 6 wherein the controller is a microprocessor, the apparatus further comprising software executing on the microprocessor for sequentially operating the pump assembly in the aspiration and purging modes

12. The apparatus defined in claim 6 further comprising software executing on the controller for actuating the pump assembly at a uniform pump rate while controlling the duration of the aspiration and purging modes with data retrieved from the database as a function of the user's selection of the liquid suspension sample.

13. The apparatus defined in claim 6 further comprising software executing on the controller for actuating the pump assembly at a uniform duration of the aspiration and purging modes while controlling pumping rate with data retrieved from the database as a function of the user's selection of the liquid suspension sample.

14. The apparatus defined in claim 6 wherein the purging mode is a manual purging mode to return the liquid suspension sample from the slide assembly back to the test tube.

15. The apparatus defined in claim 6 wherein the apparatus further comprises a stepper motor controlled by the microprocessor to actuate the pump assembly at a step rate sufficient to displace a fixed volume of a liquid suspension

16. An apparatus for transporting a volume of liquid suspensions from test tubes containing liquid suspensions which may have different viscosities for optical analysis inside a slide assembly comprising:
aspirator probe for extracting a liquid sample from a test tube and being in flow communication with the slide assembly the aspirator probe having an exterior surface;
a pump assembly controller having software to establish
i. an aspiration mode, wherein a predetermined volume of the suspension sample is displaced through the aspirator probe into the slide assembly,
ii. a purge mode, during which the predetermined volume is displaced from the slide assembly,
iii. a rinsing mode to wash the exterior of the aspirator probe; said software being responsive to an input which corresponds to a selected liquid suspension in a test tube to initiate the pump assembly to aspire a sample from the selected liquid suspension into said slide assembly and to subsequently purge the liquid suspension from the slide assembly; and
a washing station for receiving the aspirator probe upon completing the aspiration and purging modes, said washing station having a plurality of washing heads positioned to deliver a washing fluid over the exterior surface of the aspirator probe in response to a signal from the controller and a plurality of wiping elements positioned to grab the exterior surface of the probe to wipe it clean as the aspirator probe is being removed from the washing station.

17. The apparatus defined in claim 20 further comprising at least one washing head positioned to deliver washing fluid onto the wiping elements to keep them clean.

18. A method for transporting samples of diverse fluids having different viscosities from a test tube into a slide assembly through tubing using a pump located at one side of the slide assembly and for purging the slide assembly and tubing with a flushing solution located on a distal side of the pump, comprising the steps of:
storing characteristic data of respective fluids in a database wherein the characteristic data is representative of the pumping requirements to draw samples of the fluids from test tubes through the tubing into the slide assembly and for purging the fluids from the slide assembly and tubing;
generating a signal representative of a fluid stored in a test tube to initiate the drawing of a sample thereof in accordance with its associated stored characteristic data; and
activating the pump in accordance with the characteristic data specific to the particular fluid within the test tube so as to convey a sample thereof into the slide assembly and to purge the sample with said flushing solution from the slide assembly and tubing after an examination of the sample while it is within the slide assembly.

19. The method as claimed in claim 23 wherein said signal generating step further includes the steps of:
displaying a list of fluids for which characteristic data is stored;
selecting the fluid from the list to produce said signal; and
applying characteristic data associated with said selected fluid to said pump to draw a sample of the fluid from the test tube into said slide assembly.

20. The method as claimed in claim 23 and further including the steps of:
cleaning an exterior surface of a probe used to draw a sample of the fluid from the test tube after the fluid has been purged from the slide assembly and tubing; and
inhibiting the pump activating step from drawing a subsequent sample of fluid from said test tube until residue of fluid remaining on said exterior surface of the probe from a previous probe insertion into a test tube has been cleaned away.

21. The method as claimed in claim 25 wherein said cleaning step further includes the step of:
placing the probe after its removal from a test tube containing a said fluid into a washing station;
detecting the presence of the probe at the washing station; and in response to said detecting step clamping wipers against said probe so that said exterior surface of the probe is wiped upon a withdrawal of the probe from said washing station.
